(19) United States
(12) Patent Application Publication
(10) Pub. No.: US 2010/0293419 A1
(43) Pub. Date: Nov. 18, 2010

(54) AUTHORING TOOLS AND METHODS FOR IMPLEMENTING THE SAME

(75) Inventors: Shant H. Mardigian, Tujunga, CA (US); Michael Zink, Escondido, CA (US); Jeremy L. Nelson, Valencia, CA (US)

Correspondence Address: Robert D. Shedd, Patent Operations;THOMSON Licensing LLC, P.O. Box 5312, Princeton, NJ, 08543-5312, US

(73) Assignee: THOMSON LICENSING, Boulogne-Billancourt (FR)

(21) Appl. No.: 12/450,755

(22) PCT Filed: Apr. 4, 2008
(86) PCT No.: PCT/US08/04397

§ 371 Date: Jun. 1, 2010

Related U.S. Application Data
(60) Provisional application No. 60/922,978, filed on Apr. 11, 2007.

(51) Int. Cl. G06F 17/00; G06T 13/00; G06F 9/44; G06F 11/07

(52) U.S. Cl. 714/57; 345/473; 717/106; 715/202; 714/E11.025

(57) ABSTRACT

The present principles provide new tools (i.e., applications) for use in authoring Blu-Ray Discs and other media which, when used in conjunction with BD-Jive Player, the author can provide any required additional information using a user interface (UI) that does not require XML or Java coding. The user interface (UI) allows the author to express the information more generally (i.e., without having knowledge of Java coding or XML) and then the authoring tools produces the relevant XML file and Java code, as needed.

### CROSS-REFERENCE TO RELATED APPLICATIONS

This application claims priority under 35 U.S.C. 119(e) to U.S. Provisional Patent Application Ser. No. 60/922,978, filed 11 Apr. 2007, the teachings of which are incorporated herein.

### TECHNICAL FIELD

The present principles relate to Blu-ray Discs. More particularly, the present principles relate to the authoring of Blu-ray discs and other digital media.

### RELATED ART

Blu-ray discs include some content, like a movie or a game, but also include a great deal of additional information and programming that provides titles, menus, text . . . etc. This additional information is provided by an “author”. Traditionally, much of this additional information, and the formatting and organization it represents, were provided in the form of Java coding. That is, an author would write Java code that inserts menus and titles at the appropriate places in a movie, or inserts graphics at the appropriate place in a game, for example. As will be apparent from the present disclosure, it is not efficient to manually code Blu-ray titles in Java.

### BRIEF SUMMARY OF THE INVENTION

The present principles provide new tools (i.e., applications) for use in authoring Blu-Ray Discs which, when used in conjunction with BD-Jive Player, the author can provide any required additional information using a user interface (UI) that does not require XML or Java coding. Rather, the UI allows the author to express the information more generally and then an engine produces the relevant XML file and Java code, as needed.

According to an implementation, the new tools (applications) disclosed herein are referred to as JiveScript, JiveAuthor and BD-J ScriptingModule. These applications, along with BD-Jive (also interchangeably referred to herein as BD-Jive Player), provide the following advantages during the authoring of Blu-Ray Discs:
1. Authors don't need to have experience in Java or XML;
2. Speed up the development of BD-J applications;
3. Shortened the tested period since all generated code is tested and the author doesn't have to perform a very detailed unit test; and
4. Provided a user friendly UI environment.

The motivation behind taking such initiatives is the lack of tools available in the market that provide such environment for working with Blu-ray standards.

With the use of an animation engine (e.g., BD-Jive), the author provides the necessary information like menu positions, animations type and other information in the form of an XML language. Then the XML is rendered in the player to play the necessary menu items or game graphics or other features.

The author also has the option to extend the functionality of the animation engine by adding java programs. These programs perform additional tasks like navigating through the movie, saving bookmarks, and interacting with animation objects in real time. Some of these functions require interfacing with Blu-ray application programming interface (API), also referred herein as BD-J. Hence, Scripting libraries were introduced to ease this type of interface and make it friendlier to the author.

These and other aspects are achieved in accordance with an implementation, wherein the method for authoring a content storing medium includes accepting an input from an author for authoring the medium, producing in response to the author's input, a set of instructions for the authoring the medium in a language compatible for subsequent playout of the content from medium, storing the produced set of instructions on the medium, and storing content on the medium. The method can further include invoking a library routine stored on the medium in response to one or more instructions contained within the set of instructions.

The details of one or more implementations are set forth in the accompanying drawings and the description below. Even if described in one particular manner, it should be clear that implementations may be configured or embodied in various manners. For example, an implementation may be performed as a method, or embodied as an apparatus configured to perform a set of operations or an apparatus storing instructions for performing a set of operations. Other aspects and features will become apparent from the following detailed description considered in conjunction with the accompanying drawings and the claims.

### BRIEF DESCRIPTION OF THE DRAWINGS

In the drawings wherein like reference numerals refer to like elements throughout the views:

FIG. 1 is a block diagram representing library packages (JiveScript), including author scripts;

FIG. 2 is a block diagram of an illustrative embodiment of the present principles in a BD-J authoring environment;

FIG. 3 is an example of a single animation unit in a BD-J animation engine, according to an illustrative embodiment of the present principles;

FIG. 4 is an exemplary preview panel of the authoring tool (JiveAuthor) according to an illustrative embodiment of the present principles;

FIG. 5 is a graphical representation of a declaration file according to an illustrative embodiment of the present principles;

FIG. 6 is an exemplary view of a key editor screen according to an illustrative embodiment of the present principles;

FIG. 7 is an exemplary view of a message screen according to an illustrative embodiment of the present principles;

FIG. 8 is an exemplary view of a properties panel according to an illustrative embodiment of the present principles;

FIG. 9 is an exemplary view of a BDJO Image Generator interface according to an illustrative embodiment of the present principles;

FIG. 10 is an exemplary tree view of the BD-J class methods and added command/logic blocks within each method according to an illustrative embodiment of the present principles;

FIG. 11 is an exemplary view of the nested logic blocks according to an illustrative embodiment of the present principles;

FIG. 12 is an exemplary interface view of logic statements according to an illustrative embodiment of the present principles;

FIG. 13 is an exemplary view of variables presented to the author in a condition field according to an illustrative embodiment of the present principles;

FIG. 14 is an exemplary view of a first sample with one parameter according to an illustrative embodiment of the present principles;

FIG. 15 is an exemplary view of a second sample with multiple parameters according to an illustrative embodiment of the present principles;

FIG. 16 is an exemplary view showing an author's options on a particular node according to an illustrative embodiment of the present principles;

FIG. 17 is an exemplary view of the JiveScript author interface according to an illustrative embodiment of the present principles;

FIG. 18 is an exemplary view of the Jive Node selector providing the authors with a tree view of all objects within the JiveTree;

FIG. 19 is a high level block diagram of the script generation task performed by the Scripting Module according to an illustrative embodiment of the present principles;

FIG. 20 is an exemplary view of the scripting module dialog interface according to an illustrative embodiment of the present principles; and

FIG. 21 is an exemplary high level flow diagram showing the method for authoring content on a storage medium according to an illustrative embodiment of the present principles.

### DETAILED DESCRIPTION

The present principles will now be described in an effort to maintain the separation between the applications of the present principles will now be described in sections.

### JiveScript

According to an illustrative embodiment of the present principles implementation, a new application programming interface (API) has been developed. This API is referred to herein as JiveScript. The development of one particular implementation of JiveScript grew out of the desire to increase java-based Blu-Ray ROM authoring capacity. This development stream lines and eases the process of writing java code to interface with BD-J APIs by providing an easier and more descriptive interface/facade to be used by the programmer.

Those of skill in the art will recognize that BD-J is an interactive platform supporting advanced content for Blu-ray. BD-J allows bonus content on Blu-ray Disc titles to be far more sophisticated than bonus content provided by standard DVD, including, for example, network access (such as for downloading updated trailers or accessing live studio events), picture-in-picture and access to local storage. BD-J was developed by the Blu-ray Disc Association. All Blu-ray Disc players supporting video content are required to support BD-J, however none of the earlier players, with one exception (Sony PS3), support advanced features such as expanded local storage (persistent memory), picture-in-picture, or internet access. Collectively, these features (other than internet access) are referred to as “Bonus View”, and the addition of internet access is referred to as “BD Live”.

To perform certain tasks using the BD-J API requires a very large amount of redundant manual code generation. Through the use of JiveScript, the present principles provide a library of Java codes that encapsulate all the details of BD-J API and provide a very useful and friendly method and notification process for the Blu-ray author.

The JiveScript application of the present principles significantly simplifies the complexity of scripting tasks that an author would generate while producing Blu-ray BDROMs. JiveScript provides (i.e., generates) all necessary java code and logic that interfaces with BD-J APIs that encapsulates the complexity of the API, and provides the author with a more meaningful approach to dealing with authoring functionalities that are used frequently.

According to an implementation of the present principles, some of the features that the JiveScript API provides are:

1. Abstract the use of the JMFPlayer into a more simplified and easily understandable interface (Those of skill in the art will recognize that JMF Player is the default java media player that resides in a Blu-ray environment);

2. Introduce the concept of Playback Mode, whether the player is playing a main feature, a main menu, or other HD or standard-def clip;

3. The author has the option to map a playlist to more meaningful names For example, the author could map playlist “00001” to “MainFeature” or “00002” to “Trailer1” and then refer to the playlist with their names instead of the numbers. If the numbers are changes, then the author only needs to change the mapping in one place as opposed to many places in the code;

4. Easily manage audio and subtitle streams. JiveScript provides a mechanism to map streams to more meaningful names and employs a notification mechanism that notifies the author script in a single place where all necessary logic will be placed. This provides an easily maintainable code. By way of example, in this section, the audio or subtitle streams are mapped to a more meaningful name such as “commentary1” and main subtitle stream. When these subtitles are changed from any section of the code, a notification is sent to a single module. All logic needed to be performed under such conditions could be placed in one area and hence it is easily maintainable;

5. A simpler approach to play sounds by having abstracts of all the details of playing a sound in one library, and authors can use them from the UI;

6. A media notification mechanism that is easily delivered to the author's script. For example, the author will be notified when the end of the media reached and so on; and

7. Provides the author with an easier approach to add media time notification.

As mentioned above, an advantage that JiveScript provides is to hide (i.e., encapsulate) the complexity of BD-J API and provide the author with a more meaningful interface that is more aligned with our production features. A few examples of this concept are:
1. If the author wants to play the main feature, he/she will only be required to place the following script in their code:

MediaPlayer.get( )playMainFeature (“00001”);

If the author was required to do this (i.e., play the main feature) without JiveScript, he/she would have to write the following code:

```
Player player = Manager.createPlayer(new MediaLocator(new
BDLocator(“bd://PLAYLIST:00001”)));
player.addControllerListener(new ControllerListener( ){
        public void controllerUpdate(ControllerEvent ce) {
if(ce instanceof PrefetchCompleteEvent) {
            synchronized(lock) {
                lock.notify( );
            }
        }
}});
player.prefetch( );
synchronized(lock) {
    lock.wait(5000);
}
player.start( );
```

Thus, JiveScript encapsulate such functions in a library and dynamically generates a code to call such library.
2. Another example of an advantage that JiveScript provides is StreamManager's mapping and notification features. JiveScript will isolate all the mapping and perform all logic that would be otherwise required for the author to perform when an audio or subtitle stream has changed into a single place. JiveScript notifies the BDJive application on initialization, and hence the author can place commands to do stream mapping. The author could then use the mapped names throughout the application code. By way of example, JiveScript will invoke the following method on author's script to initialize the stream mapping:

```
    public void streamInfoInitData( ){
      //Author's sample initialization code is below
MediaPlayerManager.streamManager.addMainAudioMapping(“en”, 0);
MediaPlayerManager.streamManager.addMainAudioMapping(“fr”, 1);
MediaPlayerManager.streamManager.addMainAudioMapping(“sp”, 2);
    }
```

After the initialization is complete the author will receive the following notification into the same script no matter which sections of the code has changed the streams. This is necessary from the author's perceptive since the author might have to save the stream selected into the Registry or modify commentary streams when the main subtitle changes and so on:

public void streamInfoMainAudioLanguageChanged(String arg0);
public void streamInfoMainSubtitleLanguageChanged(String arg0);
public void streamInfoNarrativeLanguageChanged(String arg0);
public void streamInfoCommentaryOn(int arg0);
public void streamInfoCommentariesOff( );

For example, the author would only use the following line to change the stream to English from anywhere in the application:

MediaPlayerManager.streamManager.setMainAudioLanguage(“en”);

In turn, a notification sent to the author's script by calling a streamInfoMainAudioLanguageChanged method and passing the language that it was changed to.
3. Using JiveScript, by providing the author with an option to retrieve, the author has a way to know what the playback mode type is, which is very important in cases where you have different menus for different types of content. For example, with JiveScript, the author could very easily perform such logic, which he/she cannot do in BD-J:

if(MediaPlayer.get( ).getPlaybackMode( ) ==
MediaPlayer.FEATURE_PLAYBACK){
//perform logic here
}

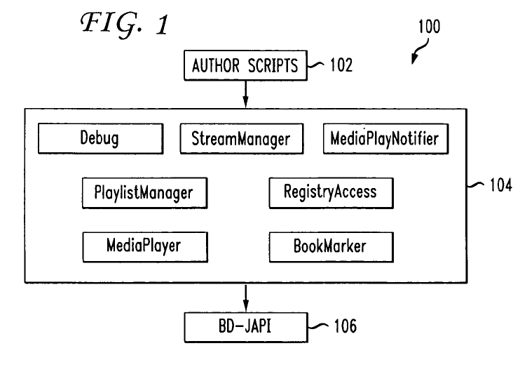

FIG. 1 shows a block diagram 100 summarizing the library packages 104 that constitute JiveScript, according to an illustrative embodiment of the present principles. The Author Scripts 102 provide an interface with the JiveScript libraries 104, where the author has access to the more meaningful names discussed above in the production environment. A Scripting Module 204 (See FIG. 2) generates the Author Scripts 102 and uses APIs available in JiveScript. The JiveScript libraries 104 respond to the author input and generate the appropriate Java code and logic to the BD-J API 106. Examples of some of the JiveScript libraries 104 include, but are not limited to, Debug, StreamManager, MediaPlayerNotifier, PlaylistManager, RegistryAccess, MediaPlayer and Bookmarker.

Those of ordinary skill in the art will recognize that JiveScript application of the present principles will assist the author in the generation of Java code and corresponding logic, however there remains the creation of XML files (e.g., databases) for the respective projects. According to a further implementation, another authoring tool, herein referred to as “Jive Author” will assist the author in creating the necessary XML files for a BDJive project.

As used herein, the term “JiveAuthor” refers to applicant's authoring tool as disclosed herein. “JiveScript” are libraries built using BD-J′s APIs. “BDJive” is an animation engine developed by applicant that handles the drawing on screen. BDJive also developed using BD-J Graphics APIs.

### JiveAuthor—BDJive XML Generator

According to an illustrative embodiment of the present principles, a system, referred to as JiveAuthor, allows the author to create the necessary XML files for a BDJive project. More specifically, the JiveAuthor system can generate the necessary XML files without requiring the author to be knowledgeable of XML language and/or all the intricacies associated with the same.

This JiveAuthor system assists the author in defining all BDJive elements from a graphical user interface. These elements include, for example, Timelines, Layers, Buttons, Graphics, Text and declared resources.

A Jive Author XML generator in accordance with the present principles expedites the process of BD-J disc authoring. It provides a set of tools, such as the JiveAuthor tool, and at least one graphical user interface that allows the author to declare resources, position graphics, declare animation and so on. In turn, the Jive Author generator will generate a BDJive compliant XML. In this manner, the author need not understand Java programming at all as it is abstracted to allow easier workflows. Some exemplary features of the JiveAuthor tool are:

1. The author is able declare images, sounds and fonts and the tool will generate the corresponding declaration tags;

2. The author is able to create BDJive elements such as Timelines, Layers, Buttons, Graphics, Text and Punch and manipulate these elements from a UI. All the corresponding XML elements will be generated;

3. The author is able to create key frames and assign different properties for each element in each frame and all the corresponding XML tags will be generated; and

4. The tool displays a graphical representation of the elements.

Those of skill in the art will recognize that there are four parts to a typical implementation the BD-J authoring environment. Referring to FIG. 2, these parts are represented by blocks 202, 204, 206, and 208. The BDJive player 206 along with JiveScript libraries 208 get included along with authors' generated content on the final disc. JiveAuthor 202 and Scripting Module 204 provide the user interfaces for authors to help them generate the content that goes on the disc.

JiveScript 208 is a set of classes/libraries that provide APIs for authors to use (i.e., MediaPlayer.playMainFeature( . . . )). JiveAuthor 202 provides the user interface (UI) to the author which generates information in XML format that the BDJive animation engine understands. JiveTree 210 and Jive Objects 214 are concepts related to the BDJive animation engine.

As an additional lens to view at least one implementation, the following summary describes the interaction of components in one implementation according to the example shown in FIG. 2. This diagram provides more of a production flow and not the actual interfaces as implemented by the present principles.

1. BDJive Player 206 provides animation for the BD-J environment, and accepts XML input(s) to invoke the animation features. BDJive is placed on a JAR File along with the generated XML/code and it runs as a BD-J application.

2. JiveAuthor 202 provides an XML-free user interface (UI) to BDJive Player 206, allowing an author to invoke the animation features of BDJive Player without explicitly writing the XML scripts. Rather, the author uses more convenient user interface tools and JiveAuthor 202 creates the corresponding XML script(s) 210.

3. JiveScript provides Java objects 214 that simplify and encapsulate various functionality provided for in the BD-J environment. These objects are invoked using Java code. An author may typically invoke these features, as well as separately using the animation features of BDJive Player.

4. BD-J Scripting Module 204 provides a Java-free interface to JiveScript, allowing an author to invoke JiveScript objects without explicitly writing Java code. Rather, the author uses more convenient user interface tools and the BD-J Scripting Module creates the corresponding Java code.

In summary, and as will be evident from the further description below, the Scripting Module 204 provides an author interface to enable the generation of the scripts 212. JiveAuthor 202 generates the JiveTree XML 210, and the JiveTree XML 210 is converted to the JiveTree Java object 214. Then, the BDJive 206 and JiveScript libraries 208 are packaged together with the JiveTree Java object 214, Scripts 212, and resources 218 into the JAR/BDJO 216.

### JiveTree (Animation Tree):

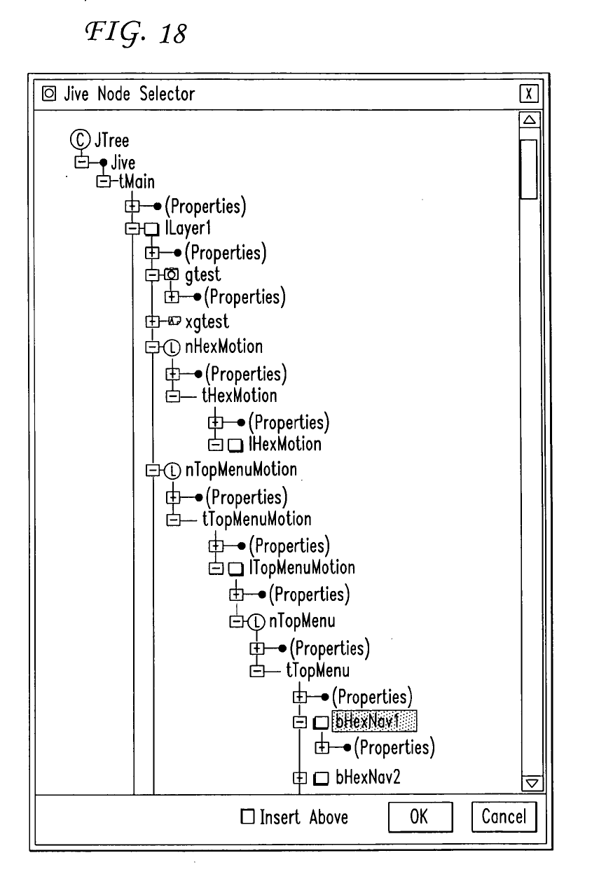

Scripting module 204 presents the animation tree (translated from XML) in a tree view to the author. As used herein, the term JiveTree is reference to this animation tree. All the possible properties of the nodes are displayed next to each node. (See for example, FIG. 18 Jive Node Selector) The author could select any property of a node, then a Java code is generated to navigate the tree (shortest path) similar to the following:

### EXAMPLE 1

this.parent.parent.parentNT.parent.parent.parentNT.parent.-
getNestedTimeline(“nHexMotion”).getTimeline( ).-
getLayer(“lHexMotion”).getNestedTimeline(“nHexMenu”).-
getTimeline( ).getLayer(“lPopupMain”).getButton(“bHexNav5”).-
setX( 10);

In the past, an author had to manually write the above code. It was a time consuming process because: 1) the author did not have a tree representation of Jive Tree view; and 2) the author could have misspelled any item and caused the code to not compile or work correctly.

BDJive 216 accepts animation information in an XML format along with some script objects. The script objects are java objects that get notified of events such as button focus gains, layer focus gains . . . etc. The author would then write some java code to perform necessary functions.

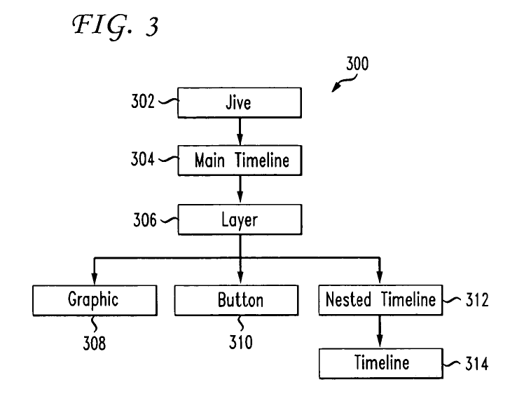

FIG. 3 shows an example of single animation unit 300 in a BDJive animation engine. Each Jive block 302 consists of main timeline 304, and each timeline 304 could one or more layers 306, where each later can have multiple Graphics 208, Buttons 310, and Nested Timeline 312 and/or additional timelines 314.

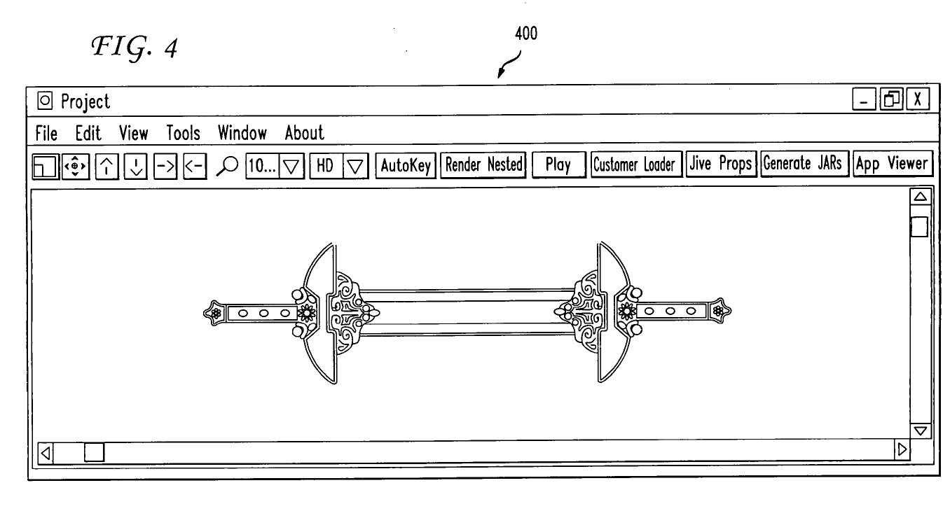

By way of Example, FIG. 4 shows a preview panel 400 according to an implementation of the authoring tool (JiveAuthor) of the present principles. In this panel, the author is able to view his/her work progress as he/she lays all the timelines, layers and other elements into the panel to create menus or other graphical elements. Then, all position information and assets used will be saved in the final XML that eventually will be rendered by BD-Jive animation engine. All the images used in this panel should first be declared in the declaration panel described in the following page.

For example, saving a simple timeline with some elements would generate an XML code as follows:

```
    <timeline id=“tPM” activeLayerIndex=“0”
frameCount=“5” frameStep=“0.0” loop=“false”
frame=“0”>
        <layer id=“lSlider” activeButtonIndex=“0”
hide=“5” z=“−10” clipWidth=“1920”
clipHeight=“1080”>
            <nestedTimeline id=“nSlider” idref=“tSlider”
            hide=“5” x=“228” y=“88”/>
        </layer>
        <layer id=“IBG” activeButtonIndex=“0” hide=“5”
        clipWidth=“1920” clipHeight=“1080”>
            <graphic id=“gBar” idref=“ibar” hide=“5”
x=“610” y=“731” width=“232” height=“212”/>
            <graphic id=“gBar1” idref=“ibar”
idrefidx=“1” hide=“5” x=“842” y=“802”
width=“280” height=“65”/>
            <graphic id=“gBar2” idref=“ibar”
idrefidx=“2” hide=“5” x=“1094” y=“731”
width=“240” height=“212”/>
        </layer>
    </timeline>
```

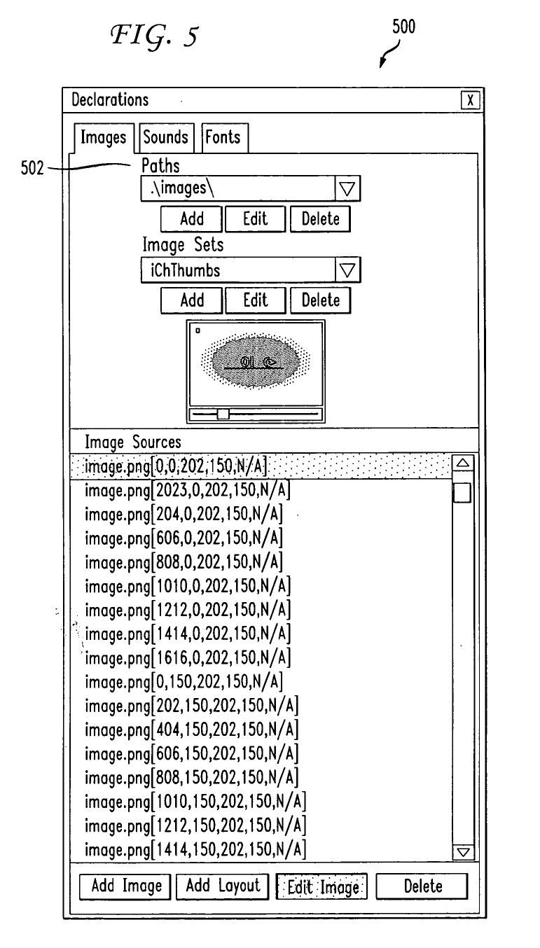

FIG. 5 shows a graphical representation of a declaration file 500 according to an illustrative embodiment of the present principles. The author can declare (e.g., import) the resources 218 (e.g., the images, sounds and fonts depicted in FIG. 2) from the above dialogue. These resources will be saved as the declaration tags in the final XML. The author can use these resources to create menus, graphical elements, play sound or display text.

First the author adds an image path 502 which represents a sub-directory in the project path. Then, the author creates an ID, via the UI, that will be used to identify the set of images that will be added. Finally, the author can drag and drop the images into this folder.

Every single image is referred to by the ID provided and the index within the list. An example of a XML generated as a result of these simple actions by the author is provided below:

```
<imgs path=“./images/”>
    <img id=“iarrowL”>
        <file src=“images.png” crop_x=“0” crop_y=“330”
        crop_width=“29” crop_height=“40”/>
        <file src=“images.png” crop_x=“29” crop_y=“330”
        crop_width=“31” crop_height=“44”/>
    </img>
</imgs>
```

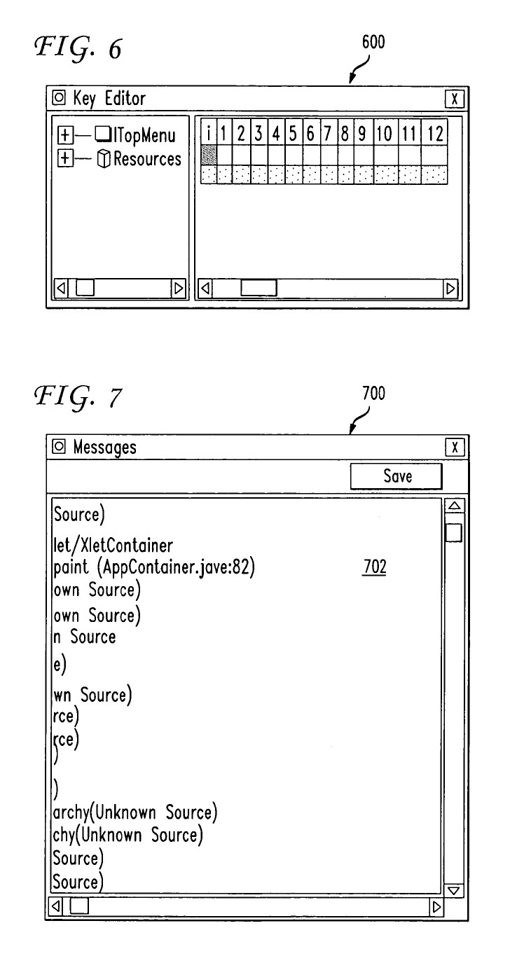

FIG. 6 shows an example of a key editor screen 600 according to an illustrative embodiment of the present principles. This key editor is a selector dialogue that presents the author with a tree view of the timeline elements and the key frames defined. Each timeline can have multiple key frames. Each key frame can have different properties and the animation engine (e.g., BD-J) will determine the rendered animation path while running in the BD-Jive animation engine. A sample XML code appears as follows:

```
<graphic id=“garrowL” idref=“iarrowL” hide=“5” x=“58” y=“547”
z=“−5” width=“29” height=“40”>
    <key frame=“0” y=“547”/>
    <key frame=“4” y=“348”/>
</graphic>
```

This sample is an example of a graphic element that has two key frames. We define one “<graphic>” for every usage of a graphic which contains multiple “<key>” tags for each key frame. The number of frames is defined by a timeline tag and these tags will only contain the key frame tags.

FIG. 7 shows an exemplary message screen 700 according to an illustrative embodiment of the present principles. All info or error messages are displayed in the message panel 702. Some of these messages are informational only and others are warnings and errors. The author can see any errors or validation problems that have occurred and which require his/her attention that ultimately could be fixed.

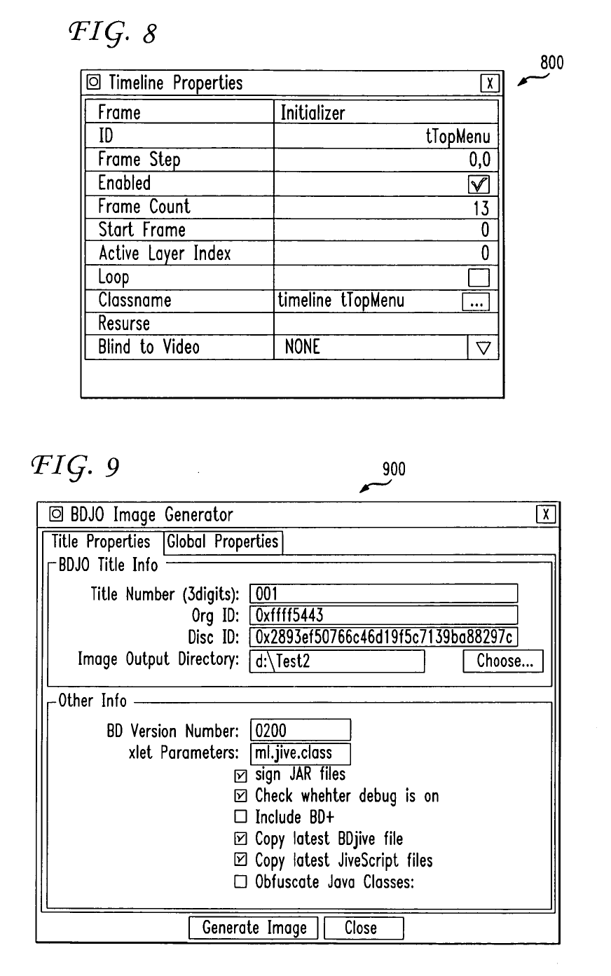

FIG. 8 shows an exemplary properties panel 800 according to an illustrative embodiment of the present principles. This panel allows the author to modify the timeline properties of the selected node and provide some validation of the same. Each property type has different entry mechanism depending on its type. The property panel 800 shows an example of a timeline properties display to the author. In this example, there are various properties (i.e., Frame, ID, Frame Step, Enabled, Frame Count, Start Frame, etc.).

For example, if the author wants to add a graphic, they would have a graphic properties display where they would be prompted to enter an image declaration that will be associated with the graphic's object. To select such property, a dialogue will appear to allow the author to select the image from a list. The property dialogue will present the author with a check box for Boolean values or a regular field for text values. Then these properties are saved in the XML.

Those of ordinary skill in the art will recognize that one of the most challenging task in authoring BDJ titles is creating the final title files which include the BDJO (title info file) and the accompanying JAR files (application files). FIG. 9 shows an example of the BDJO Image Generator interface according to an illustrative embodiment of the present principles. This generator includes an input panel that allows the author to select the necessary options (e.g., under the Title properties tab or Global properties tab) and generate set of BDJO and JAR files for a BD-J app. The author could enter the title number, Org ID, Disc ID and the output directory along with other options and press “Generate Image” and the software will create the requisite code and generate the corresponding image.

### BD-J Scripting Module

According to another illustrative embodiment of the present principles, the Scripting Module 204 (see FIG. 2) frees the users of JiveAuthor from manually writing Java code and allows authors with no Java experience to develop BD-J titles.

The BD-J scripting Module 204 is a module that consists of set of very intuitive and user-friendly graphical user interfaces (UI) along with all the necessary logic and processing elements in the background. The scripting module UIs allow the author to interact with BDJive and JiveScript as discussed above. The module creates all the necessary Java code and saves an XML database of the content on disc.

Those of skill in the art will recognize that it is not efficient to manually code Blu-ray titles in Java. The BD-J scripting module has, as one of its goals, to significantly increase the efficiency of Blu-ray Java code generation. Thus, through the application of this scripting module, the author need not have any Java experience or understanding in order to author BD-J discs.

There are no known products currently available in the market that are 100% UI driven for BD-J development. Known existing products have tried to solve this problem by providing a plug-in for a Java development IDE, however they still require the author to be experienced with Java programming and the use of the IDE as it still requires the author to write Java code in the process of authoring BD-J titles.

The BD-J Scripting module 204 of the present principles provides all necessary logic and UIs that allow the author to interface with all available Java objects within JiveScript and BDJive Player 206 (i.e. Tree interpreter). JiveScript interfaces with the BD-J API and BDJive handles all the graphics and animation of menus.

Some BDJive nodes have Java classes associated with them to perform logic like hiding menus, jumping to playlists, modifying tree nodes properties, and so on. The scripting module provides the author with the ability to create these classes and add/update all the necessary functionality from the UI. After the author finishes adding or updating the scripts, a save action will: (i) generate or update all necessary

Java classes and the associated XML database; (ii) compile the scripts; and (iii) present any errors to the author. The UI supports the following features:

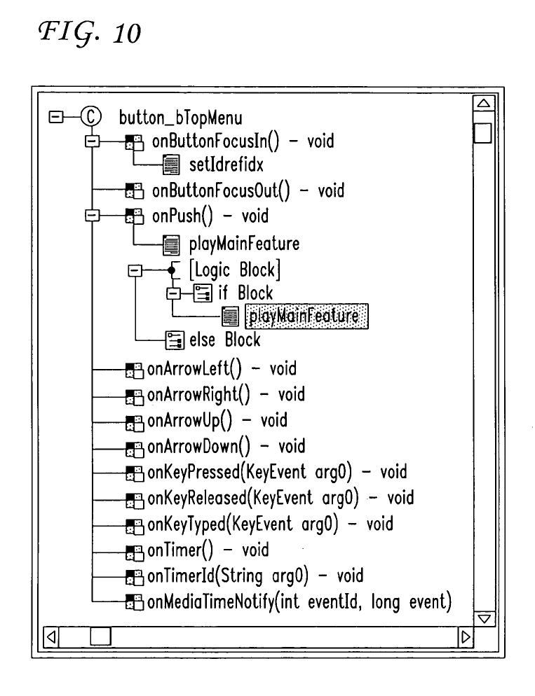

1. Presents a tree view of the BDJive classes' methods and the added commands/logic blocks within each method (See FIG. 10);

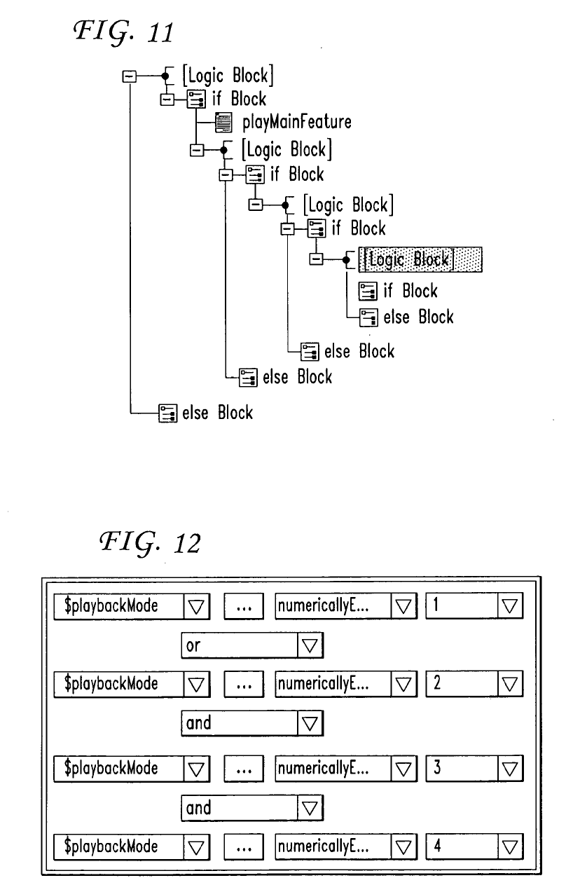

2. The author has no limit of how many nested logic blocks it could embed (See FIG. 11). Thus, the Scripting module allows an unlimited amount of nesting of logic blocks. Those of skill in the art will recognize that a logic block is a block that is executed based on a Boolean value, as a result of an expression evaluation. Thus, the author could place some functionality within the logic block which is only executed if the expression evaluates to true. The author has the option to place as many logic blocks within each other (i.e., nesting of logic blocks) without limitation. Heretofore, this concept is not available in previous products used in traditional DVD authoring. Unlimited nested blocks is desired in order to allow the creation of complex logic blocks. This aspect of the present principles is achieved by recursively navigating the nested objects and creating the necessary block Java code.

3. The author can assign values to variables and is able to re-name the variables;

4. The author can generate complex logic conditions that consist of many logic statements as shown in FIG. 12;

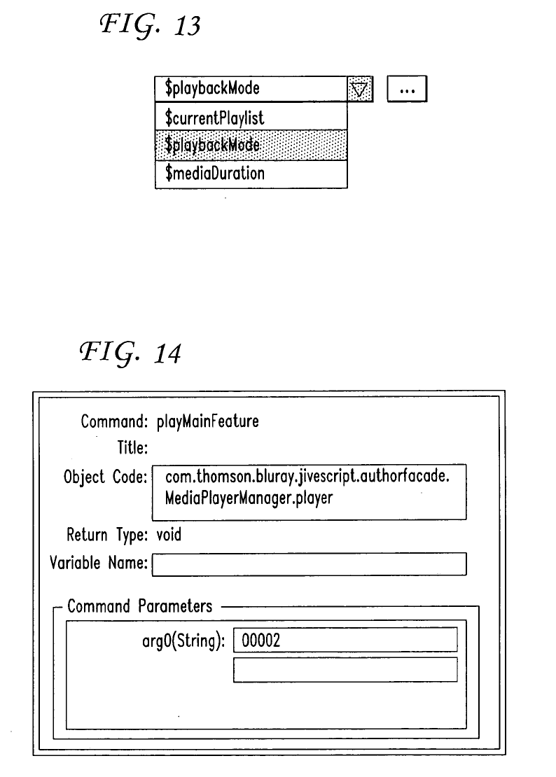

5. All the variables within scope are displayed to the author in the condition field that it could be easily selected (See FIG. 13).

6. The author could also select methods that return a value by clicking the button next to the condition field.

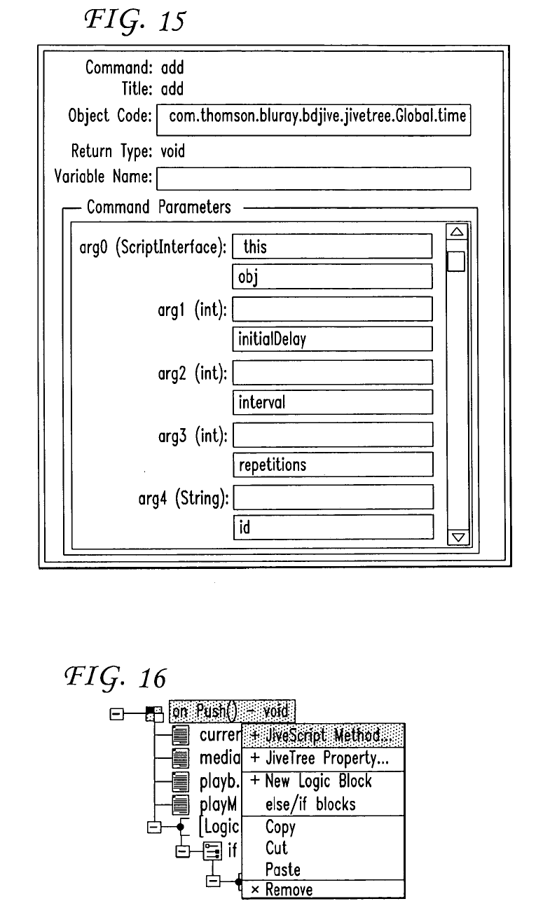

7. The scripting module will also automatically determine how many parameters a command has and displays a field for each method available in JiveScript libraries. and converts each method to a type based on their Java types and if properties are provided, it will present a description next to each argument. As mentioned above, the method is a member of a Java Object/Class that could be called to perform a certain function, and the argument is the value or another object's reference that is passed to the method for processing. FIG. 14 shows a first sample with one parameter, while FIG. 15 shows a second sample with multiple parameters.

8. The author could conveniently right click on the node and add more commands or logic blocks, remove one, copy, cut, or paste (see FIG. 16).

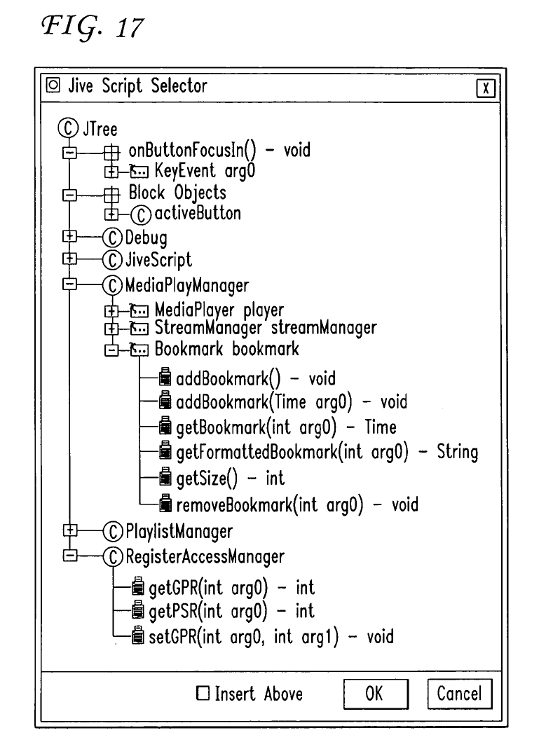

9. Scripting Module provides two sets of command selectors, one from JiveScript and another from JiveTree properties. Each window provides different interfaces. JiveScriptSelector, shown in FIG. 17 provides an interface to JiveScript API and allows access to parameters passed to the method and objects within the scope. The JiveNodeProperty Selector shown in FIG. 18 dialog presents the authors with a tree view of all the objects within JiveTree and it allows them to select any of their methods to be included as commands or their return values are saved in a variable. The tree view is generated from the XML by reading some info from BDJive objects. However, JiveScript also provides some functionalities in addition to this, and hence the interface of the present principles.

According to one illustrative embodiment of the present principles, the scripting module dynamically reads all “JiveScript” or “TreeNodes” libraries and generates the possible properties or method calls that could be made and presents the author with the corresponding options in the UI. The JiveScript or TreeNode libraries could be extended by adding new functionality and these additions would also be presented to the author in the UI modifying the Scripting module code.

10. Once a JiveTree Node is selected with its property, the scripting module is able to navigate the tree and determine the shortest path to be navigated by the generated script. For example, the following are sample codes generated from the code generated from the UI selection:

### EXAMPLE 1

this.parent.parent.parentNT.parent.parent.parentNT.parent.-
getNestedTimeline(“nHexMotion”).getTimeline( ).-
getLayer(“lHexMotion”).getNestedTimeline(“nHexMenu”).-
getTimeline( ).getLayer(“lPopupMain”).getButton(“bHexNav5”).-
setX( 10);

### EXAMPLE 2

int int7=this.parent.getGraphic(“gDisc_{—bg”).getX( );}

11. The scripting module saves all the author selected commands into an XML database in a certain format. The following is an example of an XML database:

<?xml version=‘1.0’ encoding=‘UTF-8’?>
<class name=‘button_bTopMenu’ package=‘scripts’>
...
<onPushCommands>
<command id=‘getCurrentPlaylist’ type=‘jiveScript’ returnType=‘int’ variableName=‘currentPlaylist’ >
<objectPath>com.thomson.bluray.jivescript.authorfacade.MediaPlayerManager.player</objectPath>
</command>
...
<logicBlock id=‘3’ >
<if id=‘1’>
<condition left=‘$playbackMode’ leftType=“ type=‘numericallyEqual’ right=‘1’ rightType=” ></condition>
<gate type=‘OR’/>
<condition left=‘$playbackMode’ leftType=“ type=‘numericallyEqual’ right=‘2’ rightType=” ></condition>
<gate type=‘AND’/>
<condition left=‘$playbackMode’ leftType=“ type=‘numericallyEqual’ right=‘3’ rightType=” ></condition>
<gate type=‘AND’/>
<condition left=‘$playbackMode’ leftType=“ type=‘numericallyEqual’ right=‘4’ rightType=” ></condition>
</if>
<else id=‘2’>
<condition left=“ leftType=” type=‘numericallyEqual’ right=“ rightType=” ></condition>
</else>
</logicBlock>
<command id=‘playMainFeature’ type=‘jiveScript’ returnType=‘void’ variableName=‘void1’
logicblockref=‘1’ >
<objectPath>com.thomson.bluray.jivescript.authorfacade.MediaPlayerManager.player</objectPath>
<param id=‘arg0’ type=‘String’ package=‘null’>00001</param>
</command>
</onPushCommands>
<onArrowLeftCommands>
</onArrowLeftCommands>
</class>

12. The scripting module generates the Java code automatically and it compiles it using the Java compiler. A sample auto generated code is below:

```
//AutoGenerated @start ‘onPush’
int currentPlaylist =
com.thomson.bluray.jivescript.authorfacade.MediaPlayerManager.player.getCurrentPlaylist( );
javax.media.Time mediaDuration =
com.thomson.bluray.jivescript.authorfacade.MediaPlayerManager.player.getMediaDuration( );
int playbackMode =
com.thomson.bluray.jivescript.authorfacade.MediaPlayerManager.player.getPlaybackMode( );
    com.thomson.bluray.jivescript.authorfacade.MediaPlayerManager.player.-
playMainFeature(“00002”);
    if (playbackMode == 1
        || playbackMode == 2
        && playbackMode == 3
        && playbackMode == 4) {
    com.thomson.bluray.jivescript.authorfacade.MediaPlayerManager.player.-
playMainFeature(“00001”);
        if (currentPlaylist == 1) {
            if (currentPlaylist == 2) {
                if (mediaDuration == 200000) {
                }
                else {
                }
            }
    }
this.parent.parent.parentNT.parent.parent.parentNT.parent.getNestedTimeline(“nHexMotion”).getTime
line( ).getLayer(“lHexMotion”).getNestedTimeline(“nHexMenu”).getTimeline( ).getLayer(“lPopupMain”).get
Button(“bHexNav5”).setX( 10);
    int int7 = this.parent.getGraphic(“gDisc_bg”).getX( );
//AutoGenerated @end ‘onPush’
```

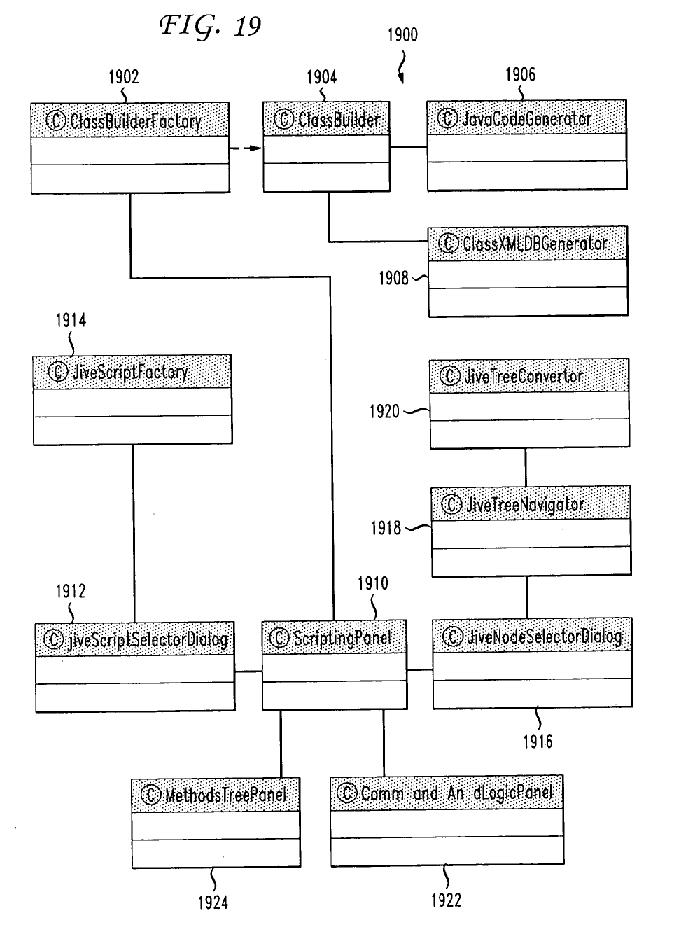

FIG. 19 is a class diagram 1900 that presents a high level view of the different software modules/packages that collectively perform the script generation task. In other words, this is a high level design diagram for BDJ-scripting module 204 according to an illustrative embodiment of the present principles. Briefly, ClassBuilderFactory 1902 is used to initialize one instance of each class used; ClassBuilder 1904 is the object responsible to generate a Java Code based on the author's functionality; JavaCodeGenerator 1906 is a utility used in code generation; JavaTreeConverter 1920 is the object that navigates the saved XML and generates a tree view of objects in memory;JiveTreeNavigator 1918 is the object that navigates the tree in memory to establish lings to other objects that the author executes commands on. The other classes 1908, 1910, 1912, 1914, 1916, 1922 and 1924 are used by the User Interface (UI) to interface with the author.

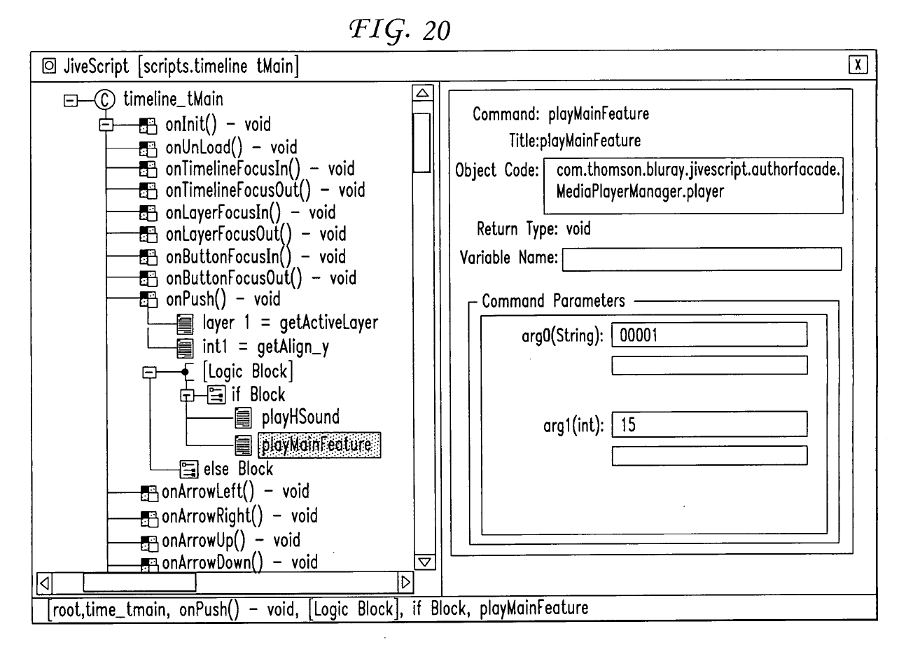

FIG. 20 shows an example of the main scripting module dialogue interface according to an illustrative embodiment of the present principles. This dialogue interface shows an example of the scripts timeline and tree view to the user. As can be seen from this example, the user has a complete view of each module (e.g., onPush( )−void) and the associated logic blocks generated in response to the same.

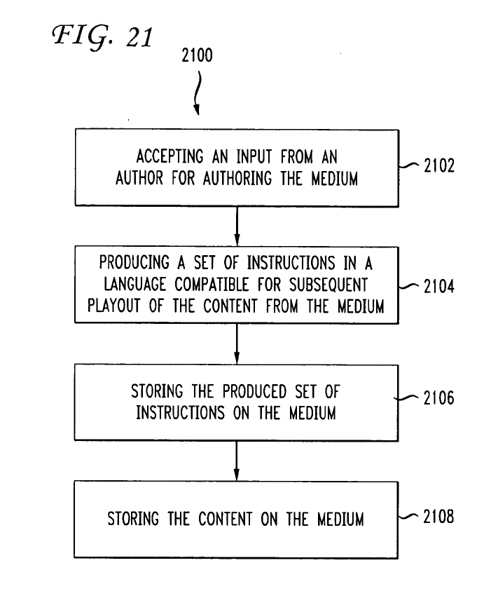

FIG. 21 shows a high level flow diagram of the method 2100 according to an illustrative embodiment of the present principles. Initially, an input is accepted (2102) from the author for authoring the medium. In response to the author input, a set of instructions are produced (2104) in a language that is compatible for subsequent playout of the content from the medium. As mentioned throughout this disclosure, this set of instructions is generated by the Scripting Module, which interfaces with the Jive Author interface used by the Author to input the set of instructions. Once the set of instructions are produced, they are saved (2106) onto the medium along with the storage (2108) of the content on the medium.

The set of instructions generated by the Scripting Module often will include one or more instructions that: 1) invoke one or more libraries (generated by JiveScript) that are also stored on the medium; and/or 2) are input into an animation engine (e.g., BDJive) that is also stored on the medium.

Those of skill in the art will recognize that is difficult to anticipate and cover all possible Java constructs to be generated from the UI of the Scripting module of the present principles. However, the Scripting module of the present principles has narrowed down the list and allows a subset of Java code elements to be included. For example, in this implementation, the “if/else” logic blocks are supported by the Scripting module. In other contemplated implementations, the Scripting module could support other Java code elements such as, for example, “for” or “while” loops.

### ADDITIONAL IMPLEMENTATIONS AND FEATURES

Features and aspects of described illustrative embodiments can also be adapted for other implementations. For example, an authoring environment may be provided for authoring digital media other than Blu-ray discs such as, for example, High Definition DVDs, or for authoring media other than DVDs. Additionally, one or more of the described features may be included in an authoring environment that is otherwise different than any of the environments described or suggested herein.

Accordingly, although implementations described herein may be described in the context of a Blu-ray disc implementation, such descriptions should in no way be taken as limiting the features and concepts to such implementations or contexts. Further, many implementations herein either receive or provide xml and/or Java code. However, it should be clear that other types of structured codes may be used, such as, for example, JavaScript/XML in HD DVD format.

The implementations described herein may be implemented in, for example, a method or process, an apparatus, or a software program. Even if only discussed in the context of a single form of implementation (for example, discussed only as a method), the implementation or features discussed may also be implemented in other forms (for example, an apparatus or program). An apparatus may be implemented in, for example, appropriate hardware, software, and firmware. The methods may be implemented in, for example, an apparatus such as, for example, a computer or other processing device. Additionally, the methods may be implemented by instructions being performed by a processing device or other apparatus, and such instructions may be stored on a computer readable medium such as, for example, a DVD, or other computer readable storage device, or an integrated circuit.

As should be evident to one of skill in the art, implementations may also produce a signal formatted to carry information that may be, for example, stored or transmitted. The information may include, for example, instructions for performing a method, or data produced by one of the described implementations. For example, a signal may be formatted to carry as data the contents of an authored Blu-ray disc.

Further, other implementations are contemplated by this disclosure. For example, additional implementations may be created by combining, deleting, modifying, or supplementing various features of the disclosed implementations.

The following list provides a short list of various implementations. The list is not intended to be exhaustive but merely to provide a short description of a small number of the many possible implementations.

1. A method for authoring content-storing medium comprising:
accepting an input for authoring the medium;
producing, in response to the input, a set of instructions for the authoring the medium in a language compatible for subsequent playout of the content from medium;
storing the produced set of instructions on the medium; and
storing content on the medium.

2. he method according to claim 1, wherein said producing a set of instructions comprises generating at least one of Java Code or XML Script in response to the instructions.

3. The method according to claim 1, wherein said step of accepting an input comprises receiving an input describing at least one operation selected from a group of operations consisting of: formatting, organizing, displaying and navigating through the content on the medium.

4. The method according to claim 1, further comprising invoking a library routine stored on the medium in response to at least one instruction within the set of instructions.

5. The method according to claim 1, further comprising inputting at least one of the set of instructions into an animation engine stored on the medium.

6. The method according to claim 5, further comprising providing a user interface with the animation engine.

7. The method according to claim 1, wherein accepting user input further comprises:
generating and saving declaration tags for user-declared resources corresponding to the content.

8. The method of claim 7, wherein said step of producing a set of instructions further comprises:
generating elements in a prescribed file format responsive to user manipulation of the resources via a user interface that can provide for display of the resources, as identified by the saved declaration tags; and
compiling the prescribed file format for execution by a media player during playout.

9. The method according to claim 1, further comprising:
displaying to the author a tree view of timeline elements and key frames defined corresponding to the produced set of instructions; and
enabling the author to make changes to the timeline and key frames prior to said storing of the set of instructions.

10. The method according to claim 9, further comprising the step of displaying a message screen showing errors relating to the set of instructions.

11. An authoring system comprising:
an animation engine for authoring, the animation engine providing features that can be invoked using a structured format; and
an animation engine interface enabling an author to invoke at least one feature of the animation engine using an author's input;
wherein the authoring engine interface converts the author's input into the structured format required by the animation engine.

12. The authoring system of claim 11, further comprising:
a set of objects configured to encapsulate features, the objects being invoked using the structured format; and
an object interface enabling the author to invoke at least one object in the set using a standard interface input;
wherein the object interface converts the author's standard interface input into the structured format required by the objects.

13. The authoring system of claim 11, wherein system operates in a BD-J environment.

14. The content storing medium authoring system of claim 12, wherein the structured format comprises one of a script or a code.

15. The content storing medium of claim 14, wherein the script comprises Java code and the code comprises XML script.

16. A computer program product comprising a computer useable medium having computer readable program code embodied thereon for use in a media production and distribution environment, the computer program product comprising:
program code for accepting an input from an author for authoring the medium;
program code for producing, in response to the author's input, a set of instructions for the authoring the medium in a language compatible with subsequent playout of the content from medium;
program code for storing the produced set of instructions on the medium; and
program code for storing content on the medium.

17. The computer program product according to claim 16, wherein said program code for producing a set of instructions further comprises program code for generating at least one of Java Code or XML Script in response to the received user instructions.

18. The computer program product according to claim 16, wherein said program code for accepting an input further comprises program code for receiving an input for describing at least one operation selected from a group of operations consisting of: formatting, organizing, displaying and navigating through the content on the medium.

19. The computer program product according to claim 16, further comprising program code for invoking a library routine stored on the medium in response to at least one instruction contained within the set of instructions.

20. The computer program product according to claim 16, further comprising program code for inputting at least one instruction into an animation engine stored on the medium.

21. The computer program product according to claim 20, further comprising program code for providing an author interface with the animation engine.

22. The computer program product according to claim 16, wherein said program code for accepting author input further comprises program code for generating and saving declaration tags for author-declared resources corresponding to the content.

23. The computer program product according to claim 22, wherein said program code for producing a set of instructions further comprises:
program code for generating elements in a prescribed file format responsive to author manipulation of the resources via an author interface that can provide for display of the resources, as identified by the saved declaration tags; and
program code for compiling the prescribed file format for execution by a media player during playout.

24. The computer program product according to claim 16, further comprising:
program code for displaying to the author a tree view of timeline elements and key frames defined corresponding to the produced set of instructions; and
program code for enabling the author to make changes to the timeline and key frames prior to said storing of the set of instructions.
